(19) United States
(12) Patent Application Publication
(10) Pub. No.: US 2013/0133366 A1
(43) Pub. Date: May 30, 2013

(54) Methods of Improving Strength of Glass Articles

(71) Applicants: Gregory Scott Glaesemann, Corning, NY (US); Aric Bruce Shorey, Painted Post, NY (US); Daniel Duane Strong, Hector, NY (US); David Alan Tammaro, Painted Post, NY (US)

(72) Inventors: Gregory Scott Glaesemann, Corning, NY (US); Aric Bruce Shorey, Painted Post, NY (US); Daniel Duane Strong, Hector, NY (US); David Alan Tammaro, Painted Post, NY (US)

(21) Appl. No.: 13/663,716

(22) Filed: Oct. 30, 2012

Related U.S. Application Data
(60) Provisional application No. 61/563,910, filed on Nov. 28, 2011.

(51) Int. Cl. C03C 23/00; C03B 27/012; C03C 21/00

(52) U.S. Cl. 65/29.18; 65/30.14; 65/61

(57) ABSTRACT

A method of improving strength of a chemically-strengthened glass article comprises exposing a target surface of the glass article to an ion-exchange strengthening process, the ion-exchange strengthening process generating a chemically-induced compressive layer in the glass article. Thereafter, dynamic interfacing of the target surface of the glass article with a sheared magnetorheological fluid is performed to remove at least a portion of the chemically-induced compressive layer from the glass article, wherein the parameters of the dynamic interfacing of the glass article with the sheared magnetorheological fluid are such that a thickness of the removed portion of the chemically-induced compressive layer is less than approximately 20% of the chemically-induced compressive layer.

This application claims the benefit of priority under 35 USC §119 of U.S. Provisional Application Ser. No. 61/563,910 filed on Nov. 28, 2011 the content of which is relied upon and incorporated herein by reference in its entirety.

### BACKGROUND

The present disclosure relates to methods of improving strength of glass articles.

### BRIEF SUMMARY

Strengthened glass can be used in many applications including, for example, large scale displays, handheld displays, touch screen displays, etc. After strengthening, the glass is relatively strong. However, in some cases, manufacturing, processing, and handling of the glass can generate small surface flaws that affect performance, even after strengthening. According to the subject matter of the present disclosure, methods of improving the strength of a glass article are described whereby a quantity of glass material is removed to minimize the quantity and significance of any surface defects extant on at least one surface of the glass article.

In accordance with one embodiment of the present disclosure, a method of improving strength of a chemically-strengthened glass article is described, the method comprising: exposing a target surface of the glass article to an ion-exchange strengthening process, the ion-exchange strengthening process generating a chemically-induced compressive layer in the glass article; and, dynamically interfacing the target surface of the glass article with a sheared magnetorheological fluid to remove at least a portion of the chemically-induced compressive layer from the glass article, wherein the parameters of the dynamic interfacing of the glass article with the sheared magnetorheological fluid are such that a thickness of the removed portion of the chemically-induced compressive layer is less than approximately 20% of the chemically-induced compressive layer.

In accordance with another embodiment of the present disclosure, a method of improving strength of a thermally-strengthened glass article is described, the method comprising: exposing a target surface of the glass article to a non-chemical strengthening process, the strengthening process generating a thermally-induced compressive layer in the glass article; and, dynamically interfacing the target surface of the glass article with a sheared magnetorheological fluid to remove at least a portion of the thermally-induced compressive layer from the glass article, wherein the parameters of the dynamic interfacing of the glass article with the sheared magnetorheological fluid are such that a thickness of the removed portion of the thermally-induced compressive layer is less than approximately 20% of the thermally-induced compressive layer.

In accordance with yet another embodiment of the present disclosure, a method of improving strength of a glass article is described, the method comprising: identifying a target surface of the glass article having at least one detectable defect; and, dynamically interfacing the target surface with a sheared magnetorheological fluid to remove at least a portion of the target surface from the glass article and at least a portion of the at least one detectable defect, wherein the parameters of the dynamic interfacing of the glass article with the sheared magnetorheological fluid are such that a thickness of approximately 1 μm is removed from the target surface.

### BRIEF DESCRIPTION OF THE SEVERAL VIEWS OF THE DRAWINGS

The following detailed description of specific embodiments of the present disclosure can be best understood when read in conjunction with the following drawing:

FIG. 1 is a schematic illustration of a method of improving strength of a chemically strengthened glass article.

### DETAILED DESCRIPTION

The present disclosure introduces methods of improving strength of glass articles. Generally, contemplated methods comprise a strengthening process and a magnetorheological fluid (MRF) processing step. As described in additional detail below, one embodiment describes a method wherein the strengthening process may comprise a non-chemical process providing a compressive layer (or layers) in the glass article. In another embodiment, the strengthening process may comprise a chemical process providing a compressive layer (or layers) in the glass article. For sake of clarity and consistency, a compressive layer imparted on the glass article by either method is referred to as a thermally-induced compressive layer (non-chemical strengthening) or a chemically-induced compressive layer (chemical strengthening). Still further contemplated embodiments relate more generally to glass articles, without regard to whether the glass article(s) have been strengthened chemically or thermally.

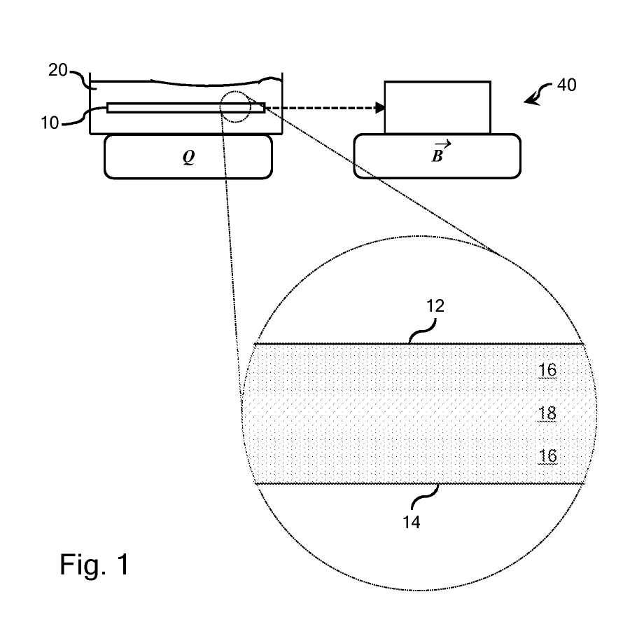

FIG. 1 is a schematic illustration of a method of improving strength of a chemically-strengthened glass article according to the present disclosure. The schematic illustration of FIG. 1 is presented for illustrative purposes only and should not be read to limit the variety of process parameters contemplated in the present disclosure. Contemplated methods of chemically-strengthening a glass article include, but are not limited to an ion exchange strengthening process and a magnetorheological fluid (MRF) processing step.

Generally, ion-exchange is a chemical-strengthening process where alkali-metal ions on the target surface are exchanged for larger alkali-metal ions provided in a salt-bath solution. The large ions are “stuffed” into the target surface area, creating a state of compression. Here, the glass is placed in a hot bath of molten salt at a temperature of approximately 300° C. Smaller sodium ions migrate from the glass to the ionized solution, and larger potassium ions migrate from the salt bath to the glass and replace sodium ions. As is illustrated in FIG. 1, these larger potassium ions take up more room and are pressed together when the glass cools, producing compressive layers 16 at the surfaces of the glass article 10 and a tension layer 18 within the subsurface of the glass, the tension layer exerting outwardly biased force on the compressive layer 16. This compression creates a surface with increased strength. An alternative chemical-strengthening process includes saturating the glass article with sodium ions at approximately 450° C. in a sodium-salt bath, followed by an ion-exchange process as recited above.

The present inventor has recognized that the compressive layers 16 will typically comprise flaws, chips, fractures, cracks, scratches, imperfections, or combinations thereof, which may be caused during formation, handling, and/or intermediate strengthening processes. To address these potential sources of failure, referring to FIG. 1, the target surfaces 12, 14 of the glass article are dynamically interfaced with a sheared magnetorheological fluid (MRF) to remove at least a portion of the chemically-induced compressive layer 16 from the glass article 10. For most forms of glass article, the parameters of the dynamic interfacing of the glass article with the sheared magnetorheological fluid are such that the thickness of the removed portion of the chemically-induced compressive layer 16 is less than approximately 20% of the compressive layer 16.

It is contemplated that, the target surface(s) of the glass article may alternatively be exposed to a non-chemical process, usually in the form of heat-based treatments, such as tempering. In another example, similar to that depicted in FIG. 1, target surface(s) 12 and/or 14 of a glass article 10 are exposed to an ion-exchange strengthening process by, for example, exposing the glass article 10 to a heated alkali-metal salt bath 20 to form chemically-induced compressive layer(s) 16 in the glass article 10. The specific parameters of the ion-exchange strengthening process, and the heat-strengthening process, are beyond the scope of the present disclosure and can be gleaned from a variety of readily available teachings on the subject. Alternatively, commercially available ion-exchange strengthening or heat-strengthening process(es) may be utilized.

It is contemplated that the target surfaces 12 and/or 14 of the glass article 10 can be subsequently interfaced with a sheared MRF, under pressure, to remove at least a portion of the chemically-induced compressive layer 16 from the glass article 10, regardless of whether the compressed layer was introduced chemically or non-chemically. It is noted that a “sheared” MRF is any MRF under an applied magnetic field \vec{B}, the magnitude and configuration of which will vary depending upon the particular configuration and properties of the glass article 10, the MRF, and the associated operating components.

In operation and according to the described embodiments, the method(s) utilizes a magnetorheological finishing apparatus 40 where the glass article 10 is interfaced with a MRF. For example, it is contemplated that the MRF apparatus 40 can include programmable hardware and can be programmed to position the glass article and respond to manual or automated commands providing relative movement (e.g. rotating or raster movement) of the glass article and a finishing head of the MRF apparatus 40. For example, the apparatus may include a selectively rotating sphere or wheel and an electromagnet positioned subjacent to the wheel surface. The electromagnet provides a field gradient of variable degree. In response to the applied field, the abrasive particles of the MRF are concentrated at or near the surface of the MRF for physically communicating with the target surface to remove or modify existing defects on the glass article 10. MRF may comprise a variety of abrasive particles, including diamond-based fluid or cerium oxide-based fluid to provide but a few examples.

In many embodiments, the parameters of the dynamic interfacing of the glass article with the sheared MRF are selected to optimize modification and/or removal of defects from the glass article 10. In addition, modification and/or removal of defects may be performed without introducing or imparting any additional defect(s) on the target surface(s). Such parameters include a thickness of the removed portion of the chemically-induced compressive layer 16 is greater than approximately 0.1 μm. In still further contemplated embodiments, the thickness of the removed portion of the chemically-induced compressive layer 16 is on the order of approximately 1 μm or, more specifically, between approximately 0.5 μm and approximately 1 μm. In other embodiments, it is contemplated that up to approximately 1.5 μm of the thickness of the chemically-induced compressive layer 16 can be removed.

It is envisioned that improved surface strength may be enhanced by increased removal depths. It is further envisioned that greater removal depths may be achieved according to the tolerance(s) for cycle time and overall improvement time criteria. Given a glass article with a thickness x, it is contemplated that less than 1% of the total average thickness x of the glass article will be removed. The modification and/or removal step(s) may be automated or programmed according to available systems integrated with existing mechanical apparatuses. The step(s) may be uniform in process and/or result, yielding increased geometric accuracy when desired.

The strengthening methodology of the present disclosure can be executed to improve strength of a chemically-strengthened glass article without the use of any chemical etching steps and the sheared MRF can be entirely non-acidic.

The strengthening methodology of the present disclosure is well suited where the glass article comprises a substantially planar display surface, in which case the parameters of the dynamic interfacing of the glass article with the sheared MRF.

In accordance with another embodiment, a method of improving the strength of a thermally-strengthened glass article, consistent with the principles of thermal treatment and the steps provided above, comprises: (a) exposing a target surface of the glass article to a thermal-strengthening process, the thermal-strengthening process generating a thermally-induced compressive layer in the glass article; and (b) dynamically interfacing the target surface of the glass article with a sheared magnetorheological fluid to remove at least a portion of the thermally-induced compressive layer from the glass article, wherein the parameters of the dynamic interfacing of the glass article with the sheared magnetorheological fluid that a thickness of the removed portion of the thermally-induced compressive layer is less than approximately 20% of the thermally-induced compressive layer.

In accordance with another embodiment, a method of improving strength in a glass article, consistent with the general principles recited above, comprises: (a) identifying a target surface of the glass article having at least one detectable defect; and (b) dynamically interfacing the target surface with a sheared magnetorheological fluid under pressure to remove at least a portion of the target surface from the glass article and at least a portion of the at least one detectable defect.

More specifically, it is envisioned that the improved glass article may be used as a display for electronic devices, including televisions, computer monitors, mobile telephones, as well as interactive interfaces for such devices, including touch-screen displays or panels for monitors, telephones, and customer service kiosks or terminals, to reference but a few examples.

It is envisioned that glass articles according to the present disclosure may include a variety of materials and be used in a variety of applications. For example, and not by way of limitation, glass articles may include the following non-exhaustive compositions, such as silica-based glass, soda-lime glass, polymer glass, including glass-ceramics, acrylic, polycarbonate, and polyethylene based materials, as well as metallic alloys, ionic melts, and molecular liquids. Moreover, glass articles contemplated herein may include materials having general application in flat-glass, container glass, network glass(es), electrolytes, and amorphous metals. More specifically, glass articles may include glass-reinforced materials (plastic(s) or concrete), thermal insulators, optics, optoelectronics, and glass art.

It is further envisioned that additional examples of objects having improved surface strength imparted by the method and its variants recited herewith may be found in the general fields of semiconductor fabrication, ceramic manufacturing, and/or other materials fabrication or processing methods presently understood, including application directed at materials that are typically characterized as hard and brittle. Materials and article dimensions having micro and/or nano structures susceptible to micro and/or nano removal and/or modification are envisioned as suitable candidates for the recited method(s) and its variants.

In the following comparative examples, glass article samples were produced having the dimensions of 50 mm by 50 mm and a uniformly square geometry. The targeted modification and/or removal region was centered to the square sample and was applied to an area comprising 30 mm by 30 mm. The removal depth was targeted for 1.5 μm to 2.0 μm. A sufficient quantity of samples were produced to allow for testing using the ring-on-ring test and the ball drop test well known and understood in the art.

### Example 1

### Comparative Example Ring-on-Ring Test Data

Three forms of surface strengthening were performed and tested for peak load strength via a ring-on-ring methodology. Group 1 is a glass article strengthened by an ion-exchange (IX) process. Group 2 is a glass article strengthened by the combination of an ion-exchange (IX) process and application of a magnetorheological fluid (MRF). For Group 2, the IX+MRF treatment removed a layer of glass approximately 1.5 μm to 2.0 μm in depth. Group 3 is a glass article strengthened by the combination of an ion-exchange (IX) process and application of hydrofluoric (HF) acid etching.

TABLE 1
Ring-on-Ring Testing Data

| | | Ave. Peak Load |
|---|---|---|
| Group | Process | (KgF) |
| 1 | IX (only) | 307 |
| 2 | IX + MRF | 538 |
| 3 | IX + HF | 691 |

From the data, the IX-only treatment provides an average peak load capacity of less-than half the capacity value that may be realized by the IX+HF acid chemical-etching combination. Importantly, the IX+MRF combination closely approximates the average peak load capacity of the IX+HF acid treatment. It is anticipated that increasing the layer-depth removed from the glass article by the IX+MRF process will further optimize the average peak load capacity value and may more closely approximate the average value provided by the IX+HF acid treatment combination.

### Example 2-Comparative Example

### Ball Drop Testing Data and Analysis

TABLE 2
Ball Drop Testing Data

| Test | | Ball Drop Height at |
|---|---|---|
| Set | Process | Failure (cm) |
| 1 | IX (only) | 40 |
| 1 | IX + HF | 295 |
| 1 | IX + MRF | 75 |
| 1 | IX + HF Set 2 | 65 |
| 2 | IX (only) | 50 |
| 2 | IX + HF | 305 |
| 2 | IX + MRF | 95 |
| 2 | IX + HF Set 2 | 170 |
| 3 | IX (only) | 50 |
| 3 | IX + HF | 315 |
| 3 | IX + MRF | 155 |
| 3 | IX + HF Set 2 | 175 |
| 4 | IX (only) | 50 |
| 4 | IX + HF | 315 |
| 4 | IX + MRF | 160 |
| 4 | IX + HF Set 2 | 210 |
| 5 | IX (only) | 50 |
| 5 | IX + HF | 315 |
| 5 | IX + MRF | 200 |
| 5 | IX + HF Set 2 | 265 |

Table 2 represents five rounds of testing of multiple glass articles that have been subjected to various strengthening processes, such as those identified in Table 1 above. The ball drop test is simply the process of dropping a steel ball from a specified height to determine threshold failure values. Each test set data comprises four strengthening processes: IX-only; IX+HF (set 1); IX+MRF; and IX+HF (set 2) to compare the different strengthening processes. The processes for IX+HF set 1 and set 2 were varied to limit the exposure time in set 2, which yielded a less optimal ball drop failure height and reduced structural integrity. Consistently, the IX-only process yielded the lowest ball drop height threshold, indicating relatively lower strength and lower damage resistance. The IX+MRF application removed approximately 1.5 μm to 2.0 μm of material from the surface of the glass article. The ball drop test data reveals that the IX+MRF treatment consistently falls within the range between the IX+HF acid treatments (set 1 and set 2). As previously noted, it is anticipated that increased depth-removal in the IX+MRF treatment will influence an upward trend in the ball drop threshold and approach optimizing ball drop data and the corresponding strength and resistance associated with the data. This suggests that IX+MRF treatments may demonstrate a strength equivalence approximating the IX+HF acid treatments commonly used for strength enhancement of glass and other objects.

For the purposes of describing and defining the present invention it is noted that the terms “approximately,” “relatively,” and “substantially” are utilized herein to represent the inherent degree of uncertainty that may be attributed to any quantitative comparison, value, measurement, or other representation. The terms “approximately,” “relatively,” and “substantially” are also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

It is noted that recitations herein of a component of the present disclosure being “configured” in a particular way, to embody a particular property, or function in a particular manner, are structural recitations, as opposed to recitations of intended use. More specifically, the references herein to the manner in which a component is “configured” denotes an existing physical condition of the component and, as such, is to be taken as a definite recitation of the structural characteristics of the component.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Rather, the claims appended hereto should be taken as the sole representation of the breadth of the present disclosure and the corresponding scope of the various inventions described herein. Further, it will be apparent that modifications and variations are possible without departing from the scope of the invention defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

It is to be understood that the embodiments and claims are not limited in application to the details of construction and arrangement of the components set forth in the description and/or illustrated in drawings or data (if provided). Rather, the description, any drawings or schematics, and/or data provide examples of the embodiments envisioned, but the claims are not limited to any particular embodiment or a preferred embodiment disclosed and/or identified in the specification. Any drawing figures that may be provided are for illustrative purposes only, and merely provide practical examples of the invention disclosed herein. Therefore, any drawing figures provided should not be viewed as restricting the scope of the claims to what is depicted.

The embodiments and claims disclosed herein are further capable of other embodiments and of being practiced and carried out in various ways, including various combinations and sub-combinations of the steps and/or features described above but that may not have been explicitly disclosed in specific combinations and sub-combinations. Accordingly, those skilled in the art will appreciate that the conception upon which the embodiments and claims are based may be readily utilized as a basis for the design of other structures, methods, and systems. In addition, it is to be understood that the phraseology and terminology employed herein are for the purposes of description and should not be regarded as limiting the claims.

What is claimed is:

1. A method of improving strength of a chemically-strengthened glass article, the method comprising:
exposing a target surface of the glass article to an ion-exchange strengthening process, the ion-exchange strengthening process generating a chemically-induced compressive layer in the glass article; and
dynamically interfacing the target surface of the glass article with a sheared magnetorheological fluid to remove at least a portion of the chemically-induced compressive layer from the glass article, wherein the parameters of the dynamic interfacing of the glass article with the sheared magnetorheological fluid are such that a thickness of the removed portion of the chemically-induced compressive layer is less than approximately 20% of the chemically-induced compressive layer.

2. A method as claimed in claim 1 wherein the parameters of the dynamic interfacing of the glass article with the sheared magnetorheological fluid are such that a thickness of the removed portion of the chemically-induced compressive layer is on the order of approximately 1 μm.

3. A method as claimed in claim 1 wherein the parameters of the dynamic interfacing of the glass article with the sheared magnetorheological fluid are such that a thickness of between approximately 0.5 μm and approximately 1 μm of the chemically-induced compressive layer is removed.

4. A method as claimed in claim 1 wherein the parameters of the dynamic interfacing of the glass article with the sheared magnetorheological fluid are such that a thickness of the removed portion of the chemically-induced compressive layer is up to approximately 1.5 μm.

5. A method as claimed in claim 1 wherein the parameters of the dynamic interfacing of the glass article with the sheared magnetorheological fluid are such that less than 1% of the total average thickness of the glass article is removed.

6. A method as claimed in claim 1 wherein the method of improving strength of a chemically strengthened glass article is substantially free of any chemical etching steps.

7. A method as claimed in claim 1 wherein the sheared magnetorheological fluid is non-acidic.

8. A method as claimed in claim 1 wherein the layer comprises flaws, chips, fractures, cracks, scratches, imperfections, or combinations thereof.

9. A method as claimed in claim 1 wherein the ion exchange process comprises exposing the glass article to a heated alkali-metal salt bath to form the chemically-induced compressive layer in the glass article.

10. A method as claimed in claim 9 wherein the heated alkali-metal salt bath comprises potassium and the glass article comprises sodium.

11. A method as claimed in claim 1 wherein the ion exchange process is characterized by the exchange of sodium and potassium.

12. A method as claimed in claim 1 wherein the method comprises:
exposing a plurality of target surfaces of the glass article to an ion-exchange strengthening process; and
dynamically interfacing the target surfaces of the glass article with a sheared magnetorheological fluid to remove at least a portion of the chemically-induced compressive layer from the glass article.

13. A method as claimed in claim 1 wherein the glass article comprises a substantially planar display surface.

14. A method as claimed in claim 1 wherein the glass article comprises respective compressive layers at major surfaces of the glass article and a tension layer within a subsurface of the glass article, the tension layer exerting force to balance the force exerted by the compressive layer.

15. A method as claimed in claim 1, wherein:
the parameters of the dynamic interfacing of the glass article with the sheared magnetorheological fluid are such that a thickness of between approximately 0.5 μm and approximately 1 μm of the chemically-induced compressive layer is removed;
the glass article is substantially free of any chemical etching; and
the sheared magnetorheological fluid is non-acidic.

16. A method of improving strength of a thermally-strengthened glass article, the method comprising:
exposing a target surface of the glass article to a non-chemical strengthening process, the strengthening process generating a thermally-induced compressive layer in the glass article; and
dynamically interfacing the target surface of the glass article with a sheared magnetorheological fluid to remove at least a portion of the thermally-induced compressive layer from the glass article, wherein the parameters of the dynamic interfacing of the glass article with the sheared magnetorheological fluid are such that a thickness of the removed portion of the thermally-induced compressive layer is less than approximately 20% of the thermally-induced compressive layer

17. A method as claimed in claim 16 wherein the non-chemical strengthening process comprises a tempering process.

18. A method of improving strength of a glass article, the method comprising:
identifying a target surface of the glass article having at least one detectable defect;
dynamically interfacing the target surface with a sheared magnetorheological fluid to remove at least a portion of the target surface from the glass article and at least a portion of the at least one detectable defect, wherein the parameters of the dynamic interfacing of the glass article with the sheared magnetorheological fluid are such that a thickness of approximately 1 μm is removed from the target surface.

19. The method as claimed in claim 18 wherein a thickness of between approximately 0.5 μm and approximately 1 μm is removed from the target surface.
